(19) United States
(12) Patent Application Publication
(10) Pub. No.: US 2025/0348404 A1
(43) Pub. Date: Nov. 13, 2025

(54) ENHANCED CONNECTIVITY PLATFORM FOR DATA SHARING BETWEEN DEVICES AND APPLICATIONS

(71) Applicant: State Farm Mutual Automobile Insurance Company, Bloomington, IL (US)

(72) Inventors: Olivia Nauman, Phoenix, AZ (US); Seth L. Corin, Cumming, GA (US)

(21) Appl. No.: 18/673,194

(22) Filed: May 23, 2024

Related U.S. Application Data
(60) Provisional application No. 63/644,124, filed on May 8, 2024.

(51) Int. Cl. G06F 11/34; G06F 21/31

(52) U.S. Cl. CPC G06F 11/3476; G06F 11/3438; G06F 21/31; G06F 2201/86

(57) ABSTRACT

An enhanced connectivity computer platform includes a central handler communicatively coupled to a plurality of user computing devices and configured to maintain a cloud-based infrastructure for a connector application, a first instance of the connector application executed on a first user computing device and configured to cause display of a GUI on the first user computing device, and a background operator of the connector application executed on the first user computing device. The platform stores activity profiles for user, receives requests for data from the activity profiles, and facilitates permissioned access to the data.

### CROSS-REFERENCE TO RELATED APPLICATIONS

The present application claims the benefit of priority to U.S. Provisional Patent Application No. 63/644,124, filed May 8, 2024, entitled “ENHANCED CONNECTIVITY PLATFORM FOR DATA SHARING BETWEEN DEVICES AND APPLICATIONS,” the entire disclosure of which is incorporated by reference herein.

### FIELD OF THE DISCLOSURE

The field of the disclosure relates generally to data sharing, and, more particularly, to data sharing across devices and applications as well as an enhanced connectivity platform enabling improved data sharing.

### BACKGROUND

People are utilizing their user computing devices for ever-increasing numbers of activities, including (but not limited to) browsing the internet, accessing social media, making purchases, sending and receiving messages, and the like. Notably, however, much of a user's interactions with different computer resources via their computing devices may be recognized and stored in a siloed manner relative to the application or functionality the user was using to access the resource when performing these activities. Conventional techniques may include additional ineffectiveness, encumbrances, inefficiencies, and drawbacks as well.

### BRIEF SUMMARY

The present embodiments may relate to, inter alia, systems and methods that enable activity logging and data sharing across multiple resources, including applications and devices. In particular, an enhanced connectivity computer platform may include a central handler server computing device and one or more user computing devices in communication with the central handler, as well as a cloud-based infrastructure for maintaining a connector app. The connector app may be downloadable and executable on a respective user computing device, and may also include executable instructions for executing a background operator on the user computing device. The enhanced connectivity platform may be configured to facilitate storage and sharing of activity profiles of the user(s) of the user computing device(s), via the connector app and/or the central handler. Thereby, the enhanced connectivity platform may facilitate using user preferences (style, music, mood, temperature, product, price preferences, etc.) and/or preferences of social media contacts (such as coffee or restaurant preferences) to provide/select products and services.

In one aspect, an enhanced connectivity computer platform may be provided. The computer platform may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be (1) in wired or wireless communication with one another, and/or (2) operate as input and/or output devices. For instance, the computer platform may include a central handler including at least one processor in communication with at least one memory device, the central handler configured to maintain a cloud-based infrastructure for a connector application downloadable and executable on a plurality of user computing devices in communication with the central handler. The computer platform may also include a first instance of the connector application executed on a first user computing device, the first instance including executable instructions causing a first processor of the first user computing device to display an interactive graphical user interface (GUI) on the first user computing device. The computer platform may further include a background operator of the connector application executed via the first processor, the background operator including executable instructions causing the first processor to: (a) log user interaction with one or more software applications executed on the user computing device; and/or (b) write an activity profile to at least one of (i) a first memory of the user computing device or (ii) the at least one memory device of the central handler, the activity profile including a plurality of logged user interactions. In response to receiving from a requestor device a first request for first information associated with a user of the first user computing device, the central handler may be configured to: (a) access the activity profile to retrieve one or more data elements responsive to the first request; and/or (b) transmit the one or more data elements to the requestor device in a response message. The computer platform may include additional, less, or alternate functionality, including that discussed elsewhere herein, and/or additional, less, or alternate components.

Methods and computer-readable storage media including computer-executable instructions to provide the same functionality may also be described herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates a block diagram of an exemplary enhanced connectivity computer platform in accordance with at least one embodiment of the present disclosure.

FIG. 2 depicts one exemplary operational flow of the enhanced connectivity platform shown in FIG. 1.

FIG. 3 depicts another exemplary operational flow of the enhanced connectivity platform shown in FIG. 1.

FIG. 4 illustrates a flow chart of an exemplary computer-implemented method implemented using the enhanced connectivity platform shown in FIG. 1.

FIG. 5 illustrates a block diagram of exemplary user computing device that may be used in the enhanced connectivity platform shown in FIG. 1.

FIG. 6 illustrates a block diagram of exemplary server computing device that may be used in the enhanced connectivity platform shown in FIG. 1.

FIG. 7 depicts a schematic diagram of the enhanced connectivity computer platform in accordance with at least one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, an enhanced connectivity computer platform, and systems and methods for providing and using the same. The enhanced connectivity platform may include a central handler (e.g., a server computing device) in network communication with a plurality of user computing devices. In the exemplary embodiment, the central handler may be configured to maintain a cloud-based infrastructure for a connector software application (herein “connector application” or “connector app”) that is downloadable, installable, and executable on any/all of the user computing devices.

The connector app may facilitate communication and, therefore, data sharing, between user computing device(s) and the central handler, between individual/multiple user computing devices, and/or between individual applications executed on a single user computing device. In some embodiments, the central handler may also be in network communication with one or more computing devices associated not with individual users but with, for example, companies or other institutions. These devices, and the parties associated therewith, may be referred to as institutional requestors. In some embodiments, the enhanced connectivity platform may further facilitate communication between user computing device(s) and institutional requestors. The data sharing described herein is conducted or performed with explicit user permission.

The systems and methods described herein may include certain opt-in requirements in order for parties to participate within the system. For example, a user using the user computing device to communicate with the central handler may register or enroll as a participating user in the system when downloading the connector app and may agree to share their data across resources and with other third-parties also participating in the system. In addition, as part of registering with the system, a user may be given the option to opt-in to the system for using certain tools and/or sharing certain information with certain parties, and not sharing certain information with other parties. Registration with the system may include acceptance of certain service terms, preferred contact information (e.g., email, SMS text notification, push notification, notification via a digital wallet service, etc.) and preferences for service notifications and the like, or other desired information relating to the user and resources being provided.

In contemplated embodiments, the registration includes opt-in informed consent of users to data usage by the system consistent with consumer protection laws and privacy regulations. In various embodiments, the registration data and/or other collected data may be anonymized and/or aggregated prior to receipt such that no personally identifiable information (PII) is received. In other embodiments, the system may be configured to receive registration data and/or other collected data that is not yet anonymized and/or aggregated, and thus may be configured to anonymize and aggregate the data. In such embodiments, any PII received by the system is received and processed in an encrypted format, or is received with the consent of the individual with which the PII is associated.

In situations in which the systems discussed herein collect personal information about individuals or may make use of such personal information, the individuals may be provided with an opportunity to control whether such information is collected or to control whether and/or how such information is used. In addition, certain data may be processed in one or more ways before it is stored or used, so that personally identifiable information is removed.

When a particular user computing device downloads, installs, and executes the connector app, that user computing device is executing or implementing an instance of the connector app. That is, each user computing device may respectively execute or implement a different instance of the connector app. Moreover, an instance of the connector app may include one or more usages or sessions of the connector app executed on the respective user computing device. In the context of the present disclosure, the sessions of the connector app may refer to the times during which the connector app is active and displayed on the user computing device. The user may actively interact with the connector app—that is, provide input to and/or receive output from the connector app—via a graphical user interface (GUI) implemented on a display of the respective user computing device.

In the exemplary embodiment, a user profile or activity profile may be generated and recorded for the user of a respective user computing device. In certain embodiments, the activity profile may be initialized when the user first executes the connector app and/or when the user registers with the enhanced connectivity platform. In some embodiments, every user that uses/accesses the enhanced connectivity platform to request and/or share data elements may be registered. Registration may include one or more forms of user verification as well, such that users may be assured that other registered users are legitimate users or entities. As the user registers with the enhanced connectivity platform, the user may provide registration data. Registration data may include, for example, age, gender, birth date/year, height, weight, and any other data associated with the user.

Additionally, during or after registration, the user manually inputs various preferences, characteristics, and permissions (collectively referred to as “manual data elements”) using the connector app. The use of the term “manual,” in this context, refers to data elements that the user provides directly to the connector app. The manual data elements, which may include the registration data, are written to the activity profile, which may be stored in a memory of the user computing device and/or in a memory of the central handler.

The enhanced connectivity platform may further include a background operator executed on each user computing device that has downloaded/executed the connector app. The background operator may include one or more processes, kernels, daemons, or other modules that are configured to operate, via the processor of the user computing device, in the background on the user computing device. That is, while the connector app may refer to active, displayed sessions of interaction between the user and the user computing device, the background operator may refer to “invisible” functions, or functions that are otherwise not actively displayed to, visible to, or recognized by the user during operation of the background operator. The background operator may, with permission, monitor and record user activity on the user computing device.

In the exemplary embodiment, the background operator may write, to the activity profile, a plurality of logged user interactions with the user computing device and, in particular, with various applications (other than the connector app) executed on the user computing device. The background operator may access the memory of the user computing device and/or the memory of the central handler to write the logged user interactions to the memory (as part of the activity profile).

Further, in some exemplary embodiments, the user may enable the enhanced connectivity platform to monitor, receive, or otherwise access data from sensors and/or devices (other than the user computing device) that are associated with the user, and to store this data or representations thereof as logged user interactions or other data elements within the activity profile. For example, sensors may include mobile device sensors (e.g., GPS, speakers, microphone), smart home device sensors (e.g., AMAZON ALEXA, GOOGLE HOME, NEST devices, and RING devices), and wearable device sensors (e.g., FITBIT, APPLE WATCH, PIXEL WATCH). Sensors may also include vehicle sensors, smart infrastructure sensors (e.g., streetlight, street, and traffic sensors), and/or smart building sensors (e.g., building cameras, building entrance/exit sensors, and utility sensors).

The logged user interactions may be interpreted or processed (e.g., by the background operator, the connector app or other module executed on the processor of the user computing device, or by the central handler) to extract trends, preferences, behaviors, and the like, as they relate to the activity on the user computing device. In the exemplary embodiment, these trends, preferences, behaviors, etc., are referred to collectively as “learned data elements,” because these data elements are learned or otherwise determined from user activity, rather than manually input by the user.

In some embodiments, the background operator may prompt the user to confirm or verify the learned data elements, via the GUI of the connector app. For example, the connector app may display learned data elements including a temperature preference for their home during the night, an alarm time preference, and a default dessert order. The user may confirm each data element, depending on whether the user determines the data element to be accurate and/or desires the data element to form part of their activity profile. In some embodiments, learned data elements may additionally or alternatively be automatically written to the activity profile.

The activity profile for a user may therefore include manual data elements, learned data elements, and/or logged user interactions, collectively referred to as “data elements.” In at least some embodiments, when recorded in the activity profile, the data elements may include or be tagged with descriptive indices that enable context-based retrieval of or access to the data elements in response to requests, as described in greater detail herein.

In the exemplary embodiment, the enhanced connectivity platform may be configured to enable sharing of data elements from activity profiles between applications executed on a single user computing device, between user computing devices, between user computing device(s) and the central handler, and/or between user computing device(s) and institutional requestors. In at least some embodiments, activity profiles may be stored in a cloud-based messaging and storage infrastructure maintained by the central handler. In some embodiments, some inter-device messaging may be described as being performed via the connector app.

In some such embodiments, where activity profiles are maintained, by the central handler, in a centralized cloud-based storage infrastructure, this messaging via the connector app may therefore invoke the central handler. For example, communications between devices may be routed through the central handler, and/or information requested by one device may be accessed via the central handler for transmission to one or more other devices. It is also contemplated that in some embodiments, where activity profiles or portions thereof are stored locally at user computing devices, inter-device messaging may bypass the central handler and/or the cloud-based storage infrastructure thereof.

In addition, the user with which the activity profile is associated has control over the storage and sharing of the activity profile and/or data element(s) thereof. Specifically, the user may interact with the connector app to input access parameters or permissions defining how the activity profile and data elements thereof may be accessed. These access parameters may include, but are not limited to include, which data element(s) are accessible by which requestors or types of requestors, which data element(s) to exclude from access by requestors or types of requestors, time-based access parameters, and the like. The user may also change, update, add, or revoke access parameters at any time.

The access parameters may additionally include verification or authorization requirements, which define how the user wishes to verify or confirm sharing of their data elements. For example, the user may input an authorization requirement that requires the connector app to activate and prompt a biometric authentication or password/PIN authentication before any data element(s) are shared in response to any request(s). As another example, the user may require such authorization for requests from institutional requestors or user computing devices that are unknown to the user computing device/connector app, whereas such authorization may not be required for requests from user computing devices that are part of the user's stored contacts. As yet another example, the user may require no authorization for the sharing of certain data element(s) that are not sensitive or personally identifiable, such as various preferences, but may require authorization for the sharing of other data element(s) that the user considers more sensitive, such as personal characteristics.

In some embodiments, the connector app may display an authorization prompt within the GUI displayed upon activation/execution of the connector app. The authorization prompt may include any relevant information that enables the corresponding user to determine whether or not they wish to authorize the data sharing. This information may include, but is not limited to, the identity of the requestor, the app within which the request was initiated, and/or the data element(s) being requested. The connector app may additionally or alternatively provide such authorization prompts in a push notification or other format that does not necessarily require the connector app to activate.

Moreover, the user may interact with the connector app to input monitoring parameters or permissions defining how the activity profile is developed, for example, using the background operator. These monitoring parameters may include, but are not limited to include, which app(s) are allowed to be monitored, which types of activities or interactions can be logged, how long activities or interactions may be stored in the activity profile, and the like. The user may also change, update, add, or revoke monitoring parameters at any time.

Therefore, the data monitoring, storage, and sharing described in the present application is explicitly authorized or permissioned by the sharing user according to their specific preferences, which may be modified at any time.

In some embodiments, data element(s) may be shared between apps executed on a same user computing device. In some instances, these apps are a same type of app or perform a similar function, such as food-ordering application, product-purchasing applications, fitness applications, etc. Some apps may be associated with institutional requestors, such as a company or other collective entity. A user's stored activity profile may include data element(s) related to a user's purchase history, preferences, habits, etc. When the user executes a new app associated with product purchases, the new app may request data element(s) from the activity profile. The connector app facilitates sharing the data element(s) with the new app, which may in turn use the shared data element(s) to initialize a user profile with the new app, populate various fields related to the user or a purchase (e.g., a shipping address), etc. In this way, a user may frequently be relieved of having to re-input data in various forms and fields, across applications, improving their user experience and saving time and effort.

In some embodiments, data element(s) may be shared between one or more recipient user computing device(s) and one or more requestor computing device(s). A request may be initialized, generated, and/or transmitted from within the GUI of the connector app. The request may include various fields and related values, such as the identity of the requestor, the data element(s) being requested, an identifier of each recipient computing device, a registration tag indicating the requestor is registered with platform 100, and the like.

In certain embodiments, one or more fields may be automatically populated by the connector app. For example, the connector app may automatically populate a field related to the identity of the requestor. In some embodiments, one or more fields may be manually populated by the user of the requestor computing device. Some fields may be responsively populated by the connector app, in response to commands or prompts from the user of the request computing device. For example, the user may select an option that indicates the intended recipient computing device(s) will be identified by capturing respective QR codes, NFC signals, BLUETOOTH signals, etc. As another example, the user may select the name (or other identifier) of a predefined group, and the connector app may responsively populate each request with a device identifier of a corresponding member of the group. The request is routed to the relevant recipient user computing device(s).

The recipient user computing device receives the request. In one embodiment, the connector app or background operator may process the request and parse the data therefrom. Based upon the request, the recipient user computing device may determine whether or not to respond to the request and, if a response is appropriate, what data element(s) to include in the response. For example, the recipient user computing device may use the access parameters (including authorization parameters) from the activity profile to determine whether and how to respond to the request.

In some embodiments, the requestor may be an institutional requestor. The request may be substantially similar to a request generated by a requestor user computing device. Likewise, the recipient user computing device may process the request in substantially the same manner as described above, and determine whether and how to respond to the request.

Various examples of this data sharing are provided herein, but it should be understood that the functionality of the enhanced connectivity platform is not limited by these examples.

### Example 1—Group Ordering

A person is responsible for a group coffee order. Conventionally, the person would collect the individual coffee orders from each member of the group, which may require significant time and effort and is subject to errors (e.g., an order may get “lost in translation” or incorrectly recorded). With the enhanced connectivity platform, the person executes the instance of the connector app on their personal user computing device. The person uses the connector app to send a request to each of the user computing devices associated with a respective group member. Based upon the activity profiles of each group member, as well as their respective access parameters, those user computing devices return, in a response message, the coffee orders or preferences of each group member. The person may then use the connector app to transmit or translate those orders to a coffee-ordering app on their user computing device, and can readily complete the group order.

In this example, each group member has an associated activity profile. In some cases, a group member has manually input their coffee preference or default/preferred coffee order as a manual data element that has been written to their activity profile. In some cases, additionally or alternatively, the group member has interacted with one or more coffee-ordering apps executed on their user computing device, and/or with websites, accessed via a mobile browser app executed on their user computing device.

With permission from the group member, the background operator executed on their user computing device has logged these user interactions in the activity profile. These logged user interactions are interpreted or processed (e.g., by the background operator, connector app, or central handler) to generate a learned data element representing the group member's coffee preference or default/preferred coffee order, and that learned data element is written to their activity profile.

Moreover, in this example, each group member has defined access parameters that are stored in or associated with their activity profile. In some cases, a group member has input an access parameter that allows access to the data element(s) associated with their coffee order or preference(s) by users that are known to the group member (e.g., users with user computing devices identified in the group member's stored contacts). The access parameter may enable automatic sharing of the data element(s) with the requestor's user computing device or may require the group member provide verification/authorization before the data element(s) is/are transmitted. In some cases, the group member has defined an access parameter that allows automatic transmission of data element(s) associated with the particular coffee-ordering app.

Continuing with this example, the group coffee order may take place in a work-related setting. In such cases, the group member may have defined an access parameter that enables automatic (or authorized) access to data element(s) related to a coffee order/preference, as well as food orders/preferences/dietary restrictions, to requests initiated by work-related contacts. However, the group member may have defined another access parameter that restricts access to data element(s) associated with preferences/orders of alcoholic drinks or preferred nightlife locations, when requests are initiated by work-related contacts. The enhanced connectivity platform enables such granular access parameters to ensure users control access to their data with reduced concern that data will be inappropriately or undesirably shared.

In another example, a person is preparing for a catered event. Before they choose a caterer, the person may wish to confirm that a particular caterer can accommodate the preferences of the event attendees. Additionally or alternatively, the person may wish to simplify the communication of attendee preferences to a caterer that has already been selected.

Continuing with this example, the person may execute their connector app and transmit a request to each attendee (or each attendee registered with the enhanced connectivity platform). The request may define the data element(s) being requested as, for example, dietary preferences, allergies, religious requirements, etc. Each attendee's respective data element(s) may be returned in respective responses—in some cases, after having been manually input or automatically populated in a response using one learned data element. The connector app may then aggregate these responses. In some instances, the connector app may display a dashboard or other interface on the GUI for access by the person. The person may transmit the responses (via the connector app or a different messaging app) to any service provider, greatly simplified and consolidating an otherwise arduous task of data collection.

### Example 2—Passive Preference Sharing

This example contemplates a person being in a restaurant or an exercise class. Over the speakers, song after song is inspired by the collective preference of the group within that venue. The venue has the preference data from the music streaming app of those within.

In certain embodiments, a person uses their user computing device to listen to music. In particular, the user may use a primary music listening app to listen to music. In accordance with the present disclosure, the background operator may monitor and log the user's listening history as part of their activity profile.

In some instances, the person downloads and executes a new music app on their user computing device. Based upon the person's access parameters, the background operator and/or the connector app may provide data element(s) associated with the person's listening history with the new music app. This data sharing may occur passively, which refers to a process that is invisible to the person, such as various background processes. That is, if permissioned by the stored access parameters, the data element(s) may be shared with the new music app without real-time user authorization, upon initialization of the new music app. In some cases, the person may define an access parameter that requires user authorization (e.g., via biometric authentication) to share the data element(s) associated with the listening history when the new music app is initialized. Once authorized, the data sharing (and, in some cases, future data sharing of updated data element(s)) may occur in the background.

In some instances, the person is present, with their user computing device, at a particular location that is playing music audible to occupants of the location. An instance of the connector app may be executed on a user computing device and/or institutional requestor device (“requestor”) associated with the location. The requestor transmits a request to the user computing device for data element(s) associated with the person's listening history. Based upon the person's access parameters, the background operator and/or the connector app may provide data element(s) associated with the person's listening history to the requestor in a response message. If permissioned by the access parameters, this data sharing may occur passively or more may require a user authorization. The requestor may then use the shared data element(s) to create or modify a playlist of the music being played in the location. In this way, the user experience may be significantly improved, because the person hears their preferred music in the location.

In some cases, there may be multiple users present, each with their own user computing device and activity profile. The requestor may transmit a request to any user computing device within a predefined location or area, and the user computing device(s) may receive and process the requests as described above. The requestor may then receive shared data elements associated with multiple listening histories from multiple user computing devices. The requestor may aggregate and process these shared data elements to identify common attributes between listening histories, and may select music to be played that best satisfies the multiple listening histories.

In certain instances, the connector app and/or background operator may be configured to contextually share data element(s) from the person's activity profile, for example, based upon a person's location, a time/date, a number or identify of other person(s) present, and the like. Continuing with the above example, the person's listening history may indicate certain preferences at different times of the day (e.g., quieter music after 8 PM), and/or certain preferences at different locations (e.g., non-explicit music when at home, when children are present, in a vehicle, etc.).

The person's activity profile may include any number of other data elements that may be shared, passively or with user authorization. As another example, the activity profile may include a manual data element that the person has a particular food allergy. The connector app and/or background operator may be configured to contextually share that data element, for example, when the person uses a food-ordering app or enters a restaurant (and a requestor computing device requests such data element(s)). In a further example, the person may enter a hotel or other similar hospitality location. The activity profile may include data elements such as a preferred temperature, a preferred “lights-out” time, a preferred “wake-up call” time, dietary restrictions, room service preferences, etc. The hotel may employ one or more requestor computing devices to request and receive the person's preferences from their activity profile, to personalize and enhance the person's experience at the location.

### Example 3—Services

In this example, a person is seeking a service provider. The person may access their connector app and define a request that requests data element(s) from other users' activity profiles. The other users may be identified by the person in the request (e.g., by user/device identifier or by an option such as “registered users within one mile”). The data element(s) being requested may include data elements related to purchase histories or habits/trends/behaviors associated with the requested service.

For instance, the person is interested in a lawncare service. The person may particularly enjoy the services provided within their neighborhood, or to a particular neighbor. The person may use the connector app to generate a request for purchase histories or contact histories related to lawncare services, and may identify the user computing device(s) to which the request is to be sent. The connector app may receive responses including, where permissioned, data element(s) responsive to the request, such as a lawncare provider listed in the contacts of the neighbor's user computing device or identified in the activity profile as a recipient of recurring transactions.

In some embodiments, such a request may additionally or alternatively leverage the person's own activity profile. For example, the person may be seeking recommendations for a hotel or a restaurant. The connector app may retrieve the person's own activity profile to identify and parse various preferences of the person. The connector app may additionally request data element(s) from other users that are identified as having similar preferences or characteristics to the person. The connector app may aggregate and process any shared data element(s) and may provide a dashboard or other interface within the GUI to display or otherwise output one or more recommendations to the person.

In some instances, a service provider may be an institutional requestor and may request certain data element(s) from the person's activity profile before, during, or after a service is performed or purchase. For example, the service provider may request and receive shared data element(s) identifying the person has a preference for e-billing rather than paper statements, a preference for being called rather than emailed, etc. Additionally or alternatively, the service provider may request and receive (aggregated and/or anonymized) data element(s) from users identified by the enhanced connectivity platform as similar to the person (e.g., based upon location, characteristics of the person, preferences of the person, etc.). For example, the service provider may request data elements associated with insurance claim histories or settlement preferences, and may process any received shared data elements to determine an appropriate service or quote to offer to the person.

“App,” as used herein, may refer generally to a software application installed and downloaded on a user computing device and executed to provide an interactive graphical user interface at the user computing device. An app associated with the computer system, as described herein, may be understood to be maintained by the computer system and/or one or more components thereof. Accordingly, a “maintaining party” of the app may be understood to be responsible for any functionality of the app and may be considered to instruct other parties/components to perform such functions via the app.

At least one of the technical problems addressed by this system may include: (i) siloed data between applications executed on a computing device; (ii) nonuniform access to data between user computing device; and/or (iii) inability for a user to define access privileges to their data. It is also recognized that the plethora of preferences social circles hold are mentally taxing to keep track of, yet critical to personalized interactions.

The enhanced connectivity platform of the present disclosure may provide technical solutions to at least these technical problems. This platform may facilitate inter-application and inter-device data sharing that is consistent and implemented according to user-set permissions and parameters. Input and learned information about a user can be stored and shared in a manner that improves connectivity without sacrificing data security, facilitating improved user experience. The data sharing between resources is therefore more secure than in at least some other systems, and the user is the owner of their own data and provided the ability and authority to securely select what data to share and with whom. The systems and methods provided herein may represent a data offering which notes and connects user preferences for use by fellow authenticated (e.g., registered) users and verified organizations. Moreover, these systems may facilitate improved user experience and/or targeted marketing, for example, where a subscription-style model may be implemented to enable organizations or institutional requestors to register or authenticate with the enhanced connectivity platform. In some instances, subscription fees from such organizations may be distributed to registered users that participate in the platform and share their user data.

The technical effects may be achieved by performing at least one of the following steps: (a) maintaining a cloud-based infrastructure for a connector application downloadable and executable on a plurality of user computing devices; (b) causing a first processor of a first user computing device to display an interactive graphical user interface (GUI) on the first user computing device; (c) logging user interaction with one or more software applications executed on the user computing device; (d) writing an activity profile to at least one of (i) a first memory of the user computing device or (ii) the at least one memory device of a central handler, the activity profile including a plurality of logged user interactions; (e) receiving from a requestor device a first request for first information associated with a user of the first user computing device; (f) accessing the activity profile to retrieve one or more data elements responsive to the first request; and/or (g) transmitting the one or more data elements to the requestor device in a response message.

### Exemplary Enhanced Connectivity Platform

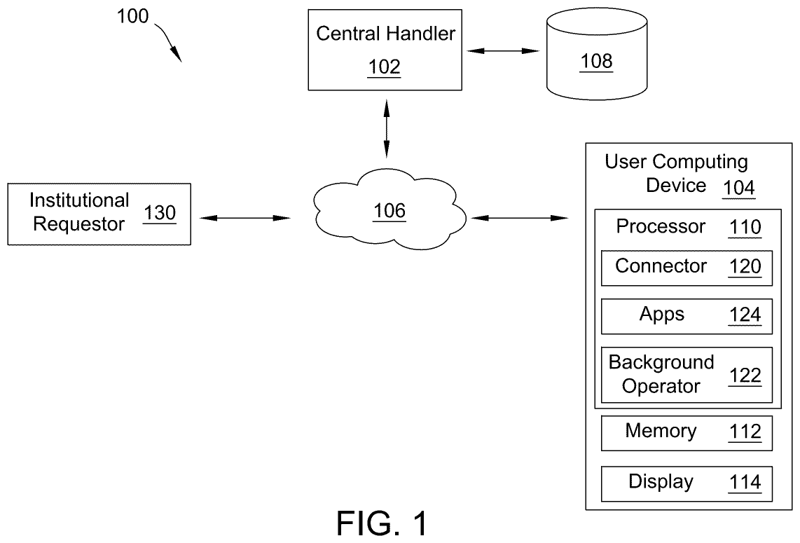

FIG. 1 illustrates a block diagram of an exemplary enhanced connectivity computer platform 100, in accordance with at least one embodiment of the present disclosure. Platform 100 includes a central handler 102 (e.g., a server computing device) in communication with a plurality of user computing devices 104 via one or more networks 106. Central handler 102 may be further in communication with one or more memory devices or databases 108. Central handler 102 may be configured to maintain a cloud-based infrastructure (e.g., via database 108 and network 106) for a connector app that is downloadable, installable, and executable on user computing devices 104. Database 108 may store any data useable within platform 100, including, but not limited to including, activity profiles (including associated data elements), logged user interactions, registration data associated with registered users of platform 100, and the like.

The connector app may facilitate communication and, therefore, data sharing, between components of platform 100 across network 106. In at least some embodiments, the connector app facilitates sending and receiving data, between parties of platform 100, over an API connection. One or more API connections may exist between, for example, user computing device 104 and central handler 102.

In some embodiments, central handler 102 may be further in communication with one or more institutional requestor devices 130 (referred to herein as institutional requestors 130). In some embodiments, platform 100 may further facilitate communication between user computing device(s) 104 and institutional requestors 130. The data sharing described herein is conducted or performed with explicit user permission.

User computing device 104 may include (at least) a processor 110, a memory 112, and a display 114. In the exemplary embodiment, user computing device 104 has downloaded, installed, and executed the connector app (shown as connector app 120), such that processor 110 of user computing device 104 is executing or implementing an instance of connector app 120. A user (not shown) of user computing device 104 may actively interact with connector app 120—that is, provide input to and/or receive output from connector app 120—via a graphical user interface (GUI) implemented on display 114.

In the exemplary embodiment, connector app 120 causes display (e.g., via display) of an interface for the user to manually input various preferences, characteristics, and permissions. These manual data elements, which may include registration data, are written to the user's activity profile, which may be stored in memory 112 and/or database 108.

A background operator 122 may also be executed on processor 110, of each user computing device 104 that has downloaded/executed connector app 120. Background operator 122 may include one or more processes, kernels, daemons, or other modules that are configured to operate, via processor 110, in the background on user computing device 104. Background operator 122 may, with permission, monitor and record user activity on user computing device 104. Specifically, in the exemplary embodiment, background operator 122 may monitor and record a plurality of logged user interactions with user computing device 104 and, in particular, with various applications 124 (other than connector app 120) executed on user computing device 104. Background operator 122 may access memory 112 of user computing device 104 and/or database 108 to write the logged user interactions to the memory (e.g., as part of a user's activity profile).

The logged user interactions may be interpreted or processed (e.g., by background operator 122, connector app 120 or other module executed on processor 110, or by central handler 102) to extract trends, preferences, behaviors, and the like, as they relate to the activity on user computing device 104. These outputs or analytics may be stored in the activity profile as learned data elements. In some embodiments, background operator 122 may prompt the user to confirm or verify the learned data elements, via the GUI of connector app 120 displayed using display 114. The user may confirm each data element, depending on whether the user determines the data element to be accurate and/or desires the data element to form part of their activity profile. In some embodiments, learned data elements may additionally or alternatively be automatically written to the activity profile.

The activity profile for a user may therefore include manual data elements, learned data elements, and/or logged user interactions, collectively referred to as “data elements.” In at least some embodiments, when recorded in the activity profile, the data elements may include or be tagged with descriptive indices that enable context-based retrieval of or access to the data elements in response to requests from requestor devices.

In platform 100, the user with which the activity profile is associated has control over the storage and sharing of the activity profile and/or data element(s) thereof. Specifically, the user may interact with connector app 120 to input access parameters or permissions defining how the activity profile may be accessed. These access parameters may include, but are not limited to include, which data element(s) are accessible by which requestors or types of requestors, which data element(s) to exclude from access by requestors or types of requestors, time-based access parameters, and the like. The access parameters may additionally include verification or authorization requirements, which define how the user wishes to verify or confirm sharing of their data elements (e.g., via biometric authentication, password, PIN, etc.).

In some embodiments, connector app 120 displays an authorization prompt within the GUI displayed upon activation/execution of connector app 120 by processor 110. The authorization prompt may include any relevant information that enables the corresponding user to determine whether or not they wish to authorize the data sharing. Connector app 120 may additionally or alternatively provide such verification prompts in a push notification or other format on display 114 that does not necessarily require connector app 120 to activate.

Moreover, the user may interact with connector app 120 to input monitoring parameters or permissions defining how the activity profile is developed, for example, by background operator 122. Therefore, the data monitoring, storage, and sharing described in the present application is explicitly authorized or permissioned by the sharing user.

In the exemplary embodiment, the enhanced connectivity platform may be configured to enable sharing of data elements from activity profiles between applications (e.g., apps 124) executed on a single user computing device 104, between user computing devices 104, between user computing device(s) 104 and central handler 103, and/or between user computing device(s) 104 and institutional requestors 130. In at least some embodiments, activity profiles are stored in a cloud-based messaging and storage infrastructure maintained by central handler 102, which may include database 108.

In certain embodiments, some inter-device messaging may be described as being performed via connector app 120. In various embodiments, where activity profiles are maintained by central handler 102 in the centralized cloud-based storage infrastructure, this messaging via connector app 120 may therefore invoke central handler 102. It is also contemplated that in some embodiments, where activity profiles or portions thereof are stored locally at user computing devices 104, inter-device messaging may bypass central handler 102 and/or the cloud-based storage infrastructure thereof.

In some embodiments, data element(s) may be shared between one or more recipient user computing device(s) 104 and one or more requestor computing device(s) 104 or institutional requestors 130. A request may be initialized, generated, and/or transmitted from within the GUI of the particular instance of connector app 120 executed on the respective device 104/130. The request may include various fields and related values, such as the identity of the requestor, the data element(s) being requested, an identifier of each recipient computing device 104, a registration tag indicating the requestor is registered with platform 100, and the like.

In some embodiments, one or more fields of the request are automatically populated by the respective instance of connector app 120. For example, connector app 120 may automatically populate a field related to the identity of the requestor. In some embodiments, one or more fields are manually populated by the user of the requestor computing device 104. Some fields may be responsively populated by connector app, in response to commands or prompts from the user of the request computing device. The request is routed to the relevant recipient user computing device(s) 104 (e.g., over network 106 and/or via central handler 102).

The recipient user computing device 104 receives the request. In one embodiment, the respective instance of connector app 120 executed on the recipient user computing device or background operator 122 may process the request and parse the data therefrom. Based upon the request, the recipient user computing device may determine whether or not to respond to the request and, if a response is appropriate, what data element(s) to include in the response.

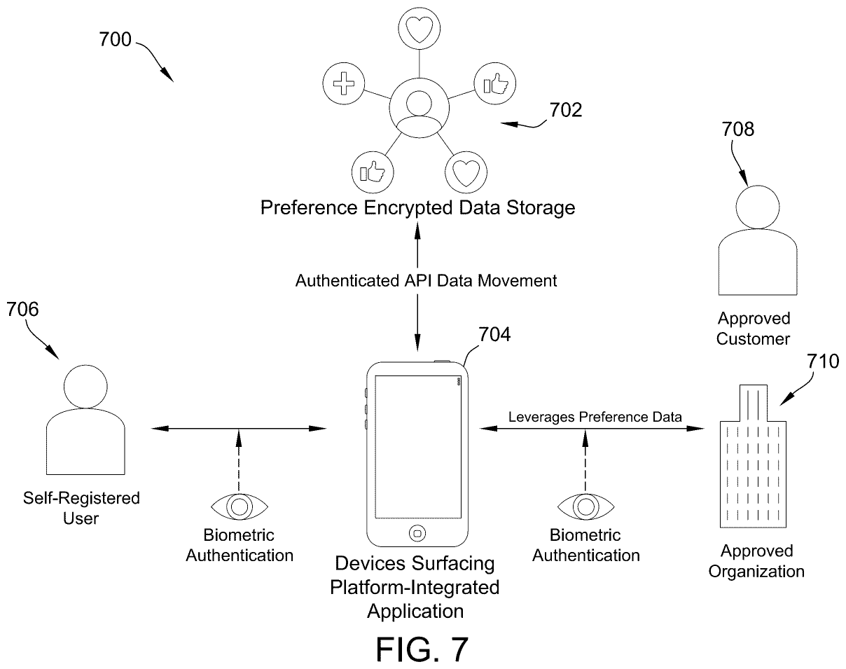

FIG. 7 depicts a schematic diagram of an exemplary enhanced connectivity computer platform 700, which may be substantially similar to platform 100. In this exemplary embodiment, platform 700 may include a centralized cloud-based infrastructure 702 for the storage and sharing of data, such as user preferences. Cloud-based infrastructure 702 may be communicatively coupled to one or more user computing devices 704 via authenticated API-based communication channels.

Users 706 may access their user computing device 704 to execute a platform-integrated application (e.g., a connector app). In one exemplary embodiment, users 706 are registered or authenticated with platform 700. In this way, users 706 may have greater confidence interacting with other entities to share their data over platform 700. In certain embodiments, user 706 initiates a biometric authentication to execute the platform-integrated application and/or to share data according to their defined rules and parameters.

Users 706 may selectively transmit or share data elements with other users, represented as consumers 708, and/or other entities such as businesses, represented as organization 710. In certain embodiments, consumers 708 and/or organizations 710 may be registered with platform 700, or may be otherwise authenticated or approved by platform 700. Consumers 708 and/or 710 may initiate respective biometric authentications, to enable these entities to send requests and/or to receive shared data elements, such as user preferences.

Platforms 100 and 700 may facilitate user-drive personalization, reframing data access and sharing to a decentralized Web3 paradigm, thereby putting privacy of user data into the hands of users themselves. Moreover, platforms 100 and 700 may facilitate community alignment. enabling users and organization to connect more intimately on the users' desires, leading to more satisfied individuals and social circles.

### Exemplary Operational Flow within the Enhanced Connectivity Platform

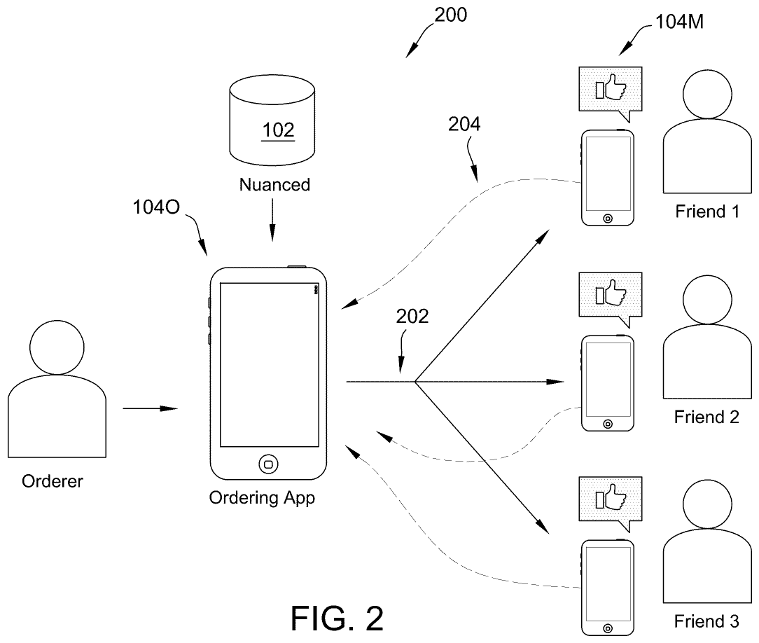

FIG. 2 depicts one exemplary operational flow 200 of enhanced connectivity platform 100, shown in FIG. 1. This operational flow 200 contemplates a person being amongst friends or coworkers, and it comes time for coffee or a meal. They would like to have a single person order & pay, but they need to collect everyone's order. The person (“orderer”) is able to simply ask that all users approve the visibility to their preferred coffee order, and may place the group order without leaving a coffee shop app.

As shown in FIG. 2, the orderer is responsible for a group coffee order. The orderer executes the instance of the connector app, which may be integrated with or separate from an institutional coffee-ordering app, on their personal user computing device 1040. The orderer uses the connector app to send a request 202 to each of a plurality of user computing devices 104M respectively associated with a corresponding group member. Based upon the activity profiles of each group member, as well as their respective access parameters, those user computing devices 104M return, in response messages 204, the coffee orders or preferences of each group member. The orderer may then use the connector app to transmit or translate those orders to a coffee-ordering app on their user computing device, and can readily complete the group order.

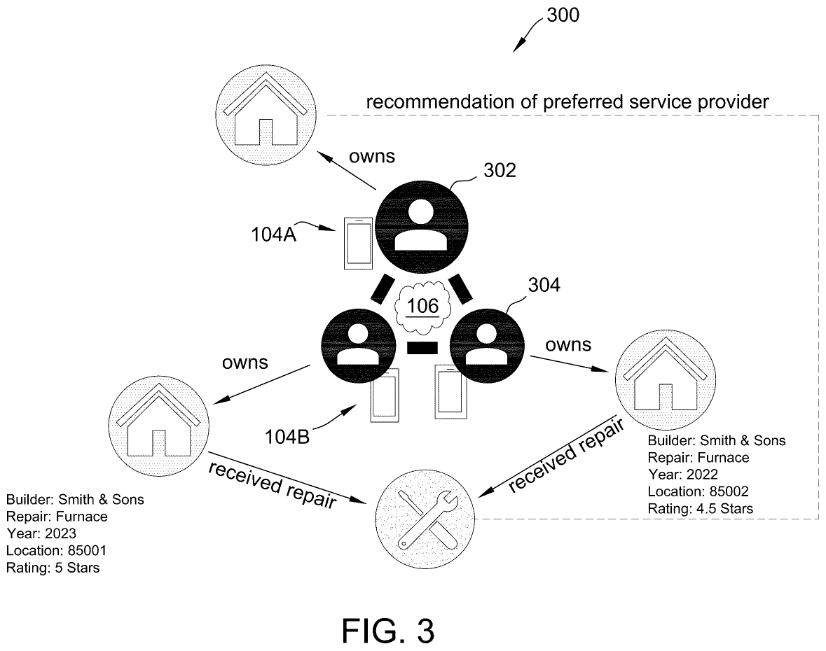

FIG. 3 depicts another exemplary operational flow 300 of enhanced connectivity platform 100, shown in FIG. 1. In this example, a person 302 is seeking a service provider. Person 302 may access the instance of the connector app executed on their user computing device 104A and define a request that requests data element(s) from activity profiles of other users 304. The other users 304 may be identified by person 302 in the request (e.g., by user/device identifier or by an option such as “registered users within one mile”). The data element(s) being requested may include data elements related to purchase histories or habits/trends/behaviors associated with the requested service.

For instance, person 302 is interested in a repair service. Person 304 may use the connector app to generate a request for purchase histories or contact histories related to repair services. Person 304 may identify the user computing device(s) 104B of the users 304 to which the request is to be sent. For example, person 304 may identify users 304 based upon their contacts or based upon users 304 being within a selected geographic range. The connector app may receive responses from users 304, via user computing devices 104B and the respective instances of the connector app executed thereon, including, where permissioned, data element(s) responsive to the request. These data elements may include, for example, a repair provider listed in the contacts of user computing device(s) 104B or identified in the activity profile of user(s) 304 as a recipient of recurring transactions. The connector app may aggregate and process any shared data element(s) and may provide a dashboard or other interface within the GUI to display or otherwise output one or more recommendations to person 304.

### Exemplary Computer-Implemented Method

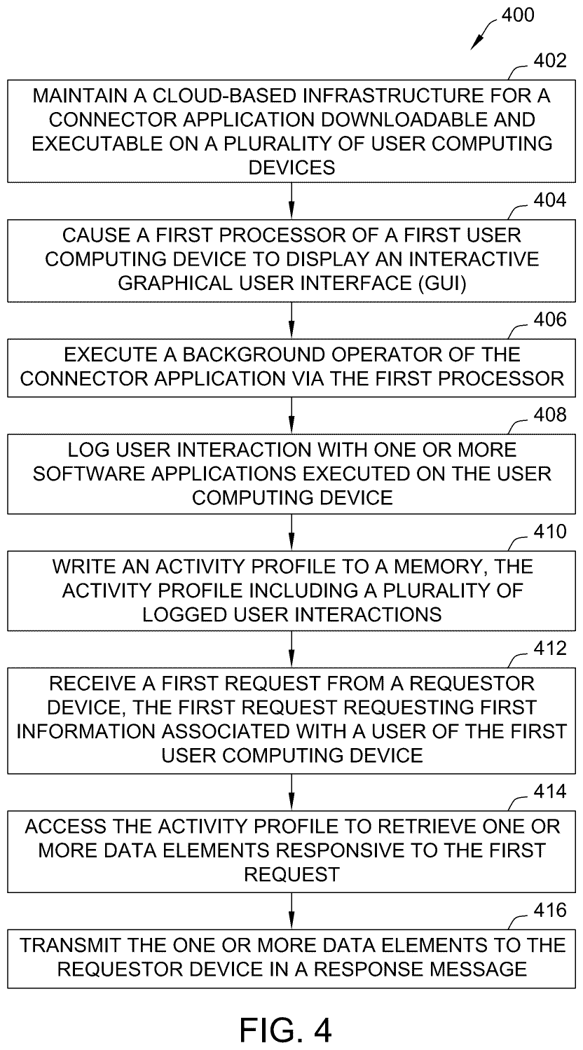

FIG. 4 illustrates a flow chart of an exemplary computer-implemented method 400 for enabling permissioned data sharing between computing resources. Method 400 may be implemented at least in part using platform 100, including central handler 102, database 108, and/or user computing device 104.

Method 400 may include maintaining 402 a cloud-based infrastructure for a connector application downloadable and executable on a plurality of user computing devices, and causing 404 a first instance of the connector application executed on a processor of the first user computing device to display an interactive graphical user interface (GUI).

Method 400 may also include executing 406 a background operator of the connector application via the first processor and, via the background operator, logging 408 user interaction with one or more software applications executed on the user computing device and writing 410 an activity profile to a memory, the activity profile including a plurality of logged user interactions.

Method 400 may further include receiving 412 a first request from a requestor device, the first request requesting first information associated with a user of the first user computing device. Method 400 may include, in response to the receiving 412, accessing 414 the activity profile to retrieve one or more data elements responsive to the first request and transmitting the one or more data elements to the requestor device in a response message.

Method 400 may include additional, alternative, or fewer actions, operations, and/or steps, including those detailed elsewhere herein.

### Exemplary User Computing Device

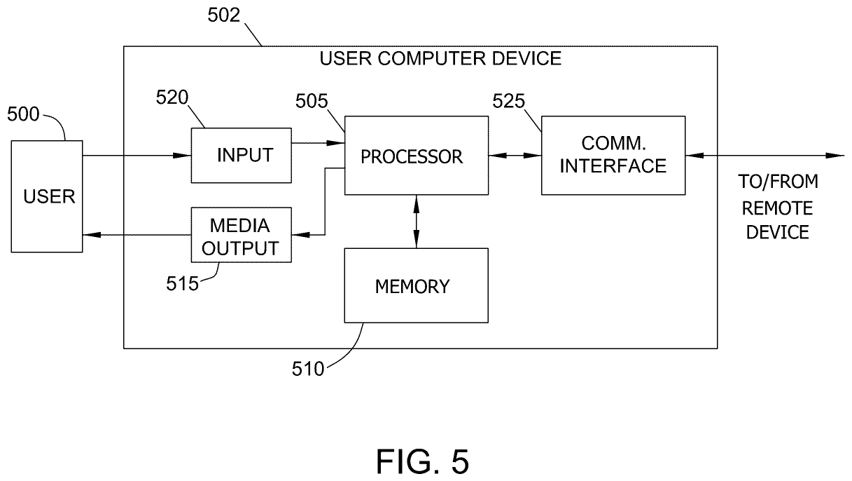

FIG. 5 depicts an exemplary configuration of a user computer device 502 that may be operated by a user 500. User computer device 502 may include, but is not limited to, user computing device 104 and/or requestor device 130 (all shown in FIG. 1). User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions, activity profiles, logged user interactions, learned data elements, manual data elements, contacts, and/or any other relevant data to be stored and retrieved. Memory area 510 may include one or more computer-readable media.

User computer device 502 may also include at least one media output component 515 for presenting information to user 500. Media output component 515 may be any component capable of conveying information to user 500. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (eXtended Reality) headsets).

In some embodiments, media output component 515 may be configured to present a graphical user interface (e.g., within a web browser and/or a client application) to user 500. A graphical user interface may include, for example, an interface for prompting a user to enter preferences or access/monitoring parameters, an interface for a user to provide a request or to see responses, etc. In some embodiments, user computer device 502 may include an input device 520 for receiving input from user 500. Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device. Communication interface 525 may include, for example, a wired or wireless network adapter and/or a wireless data transceiver for use with a mobile telecommunications network.

Stored in memory area 510 are, for example, computer readable instructions for providing a user interface to user 500 via media output component 515 and, optionally, receiving and processing input from input device 520.

Processor 505 executes computer-executable instructions for implementing aspects of the disclosure. In some embodiments, processor 505 is transformed into a special purpose microprocessor by executing computer-executable instructions or by otherwise being programmed.

### Exemplary Server Device

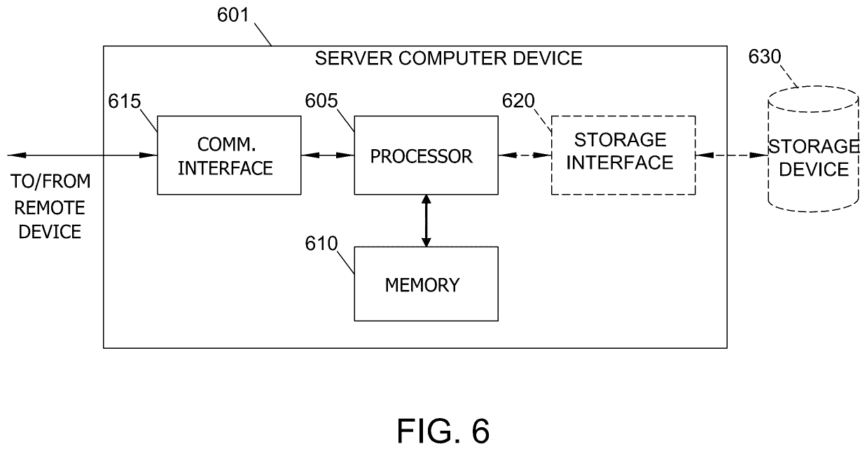

FIG. 6 depicts an exemplary configuration of server computer device 601, in accordance with one embodiment of the present disclosure. Server computer device 601 may include, but is not limited to, central handler 102 and/or requestor devices 130 (all shown in FIG. 1). Server computer device 601 may include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device. For example, communication interface 615 may receive messages from remote devices via the Internet.

Processor 605 may also be operatively coupled to a storage device 630. Storage device 630 may be any computer-operated hardware suitable for storing and/or retrieving data, such as, but not limited to, data stored in with database 108 or memory 112 (shown in FIG. 1). In some embodiments, storage device 630 may be integrated in server computer device 601. For example, server computer device 601 may include one or more hard disk drives as storage device 630.

In other embodiments, storage device 630 may be external to server computer device 601 and may be accessed by a plurality of server computer devices 601. For example, storage device 630 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 630 via a storage interface 620. Storage interface 620 may be any component capable of providing processor 605 with access to storage device 630. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 630.

Processor 605 may execute computer-executable instructions for implementing aspects of the disclosure. In some embodiments, processor 605 may be transformed into a special purpose microprocessor by executing computer-executable instructions or by otherwise being programmed. For example, processor 605 may be programmed with instructions such as those illustrated in FIG. 4.

### Exemplary Embodiments & Functionality

In one embodiment of the present disclosure, an enhanced connectivity computer platform may be provided. The platform may include a central handler including at least one processor in communication with at least one memory device, the central handler configured to maintain a cloud-based infrastructure for a connector application downloadable and executable on a plurality of user computing devices in communication with the central handler. The platform may also include a first instance of the connector application executed on a first user computing device, the first instance including executable instructions causing a first processor of the first user computing device to display an interactive graphical user interface (GUI) on the first user computing device. The platform may further include a background operator of the connector application executed via the first processor, the background operator including executable instructions causing the first processor to: (a) log user interaction with one or more software applications executed on the first user computing device; and/or (b) write an activity profile to at least one of (i) a first memory of the first user computing device or (ii) the at least one memory device of the central handler, the activity profile including a plurality of logged user interactions. In response to receiving from a requestor device a first request for first information associated with a user of the first user computing device, the central handler may be configured to: (a) access the activity profile to retrieve one or more data elements responsive to the first request; and/or (b) transmit the one or more data elements to the requestor device in a response message.

In one aspect, the requestor device may be another software application executed on the first user computing device. In some aspects, the another software application may be a newly executed software application being executed on the first user computing device for a first time and is a first type of application. The first request for first information may request the one or more data elements related to logged user interactions with previously executed applications of a same or similar type to the newly executed software application.

In some aspects, wherein the requestor device may be a second user computing device communicatively coupled to the first user computing device. In some instances, the first request may be initiated with a second instance of the connector application executed on the second user computing device.

In some further aspects, at least one of the background operator or the central handler may be configured to process the logged user interactions to generate a plurality of learned data elements identifying preferences of the first user. In some cases, the first instance of the connector application may further cause the first processor to display the GUI including the preferences of the first user and a request for validation of the preferences. In some aspects, the first instance of the connector application may further cause the first processor to receive user input from the GUI including user validation of at least one of the preferences. Additionally, the first instance of the software application or the background operator may further cause the first processor to write the plurality of learned data elements to the activity profile when the preferences are validated by the first user.

In certain aspects, the first instance of the connector application may further cause the first processor to display the GUI including an interface prompting the first user to provide user input including user preferences. In some embodiments, the first instance of the software application or the background operator may further cause the first processor to: (a) generate a plurality of manual data elements representing the user preferences; and/or (b) write the plurality of manual data elements to the activity profile.

In some additional aspects, the first instance of the connector application may further cause the first processor to display the GUI including an interface prompting the first user to provide user input including access parameters. In some cases, the central handler may be further configured to determine, based upon the access parameters, the requestor device has permission to access the activity profile and the one or more data elements. Additionally, the access parameters may define which entities have permission to access the activity profile, and which data elements of the activity profile can be accessed by each of the entities.

In some aspects, the one or more data elements may be a subset of a plurality of data elements forming the activity profile.

In some aspects, the first instance of the connector application may further cause the first processor to display the GUI including an interface prompting the first user to provide user input including monitoring parameters. In certain cases, the monitoring parameters may define which applications executed on the first user computing device that the background operator has permission to monitor, what types of user interactions that the background operator has permission to log, or how long to store the logged user interactions within the activity profile. In some instances, the background operator may be restricted to function within the monitoring parameters.

In some further aspects, the logged user interactions may be stored with descriptive indices that enable accessing the associated data elements in response to different types of requests.

In certain aspects, the first instance of the connector application may further cause the first processor to display a prompt for the first user to provide biometric authentication data before permitting the central handler to access the activity profile or transmit the response message.

In some aspects, the first instance of the connector application may further cause the first processor to display a prompt for the first user to provide a password before permitting the central handler to access the activity profile or transmit the response message.

In some further aspects, the central handler may be further configured to maintain a repository of registered users that are registered with the enhanced connectivity computer platform. In some cases, the registered users may include at least one institutional requestor. In some instances, the first request may include a registration tag indicating the requestor device is or is associated with one of the registered users.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as user activities, preferences, trends, patterns, habits, image, video, vehicle telematics, home telematics, autonomous vehicle, smart vehicle, and/or intelligent home data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

In yet another embodiment, a ML module may employ reinforcement learning, which may involve optimizing outputs based upon feedback. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT.

The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

### Additional Considerations

Described herein are computer systems such as the computer devices and related computer systems forming the enhanced connectivity platform. As described herein, all such computer systems include a processor and a memory. However, any processor in a computer device referred to herein can also refer to one or more processors wherein the processor can be in one computing device or a plurality of computing devices acting in parallel. Additionally, any memory in a computer device referred to herein can also refer to one or more memories wherein the memories can be in one computing device or a plurality of computing devices acting in parallel.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein may include or be implemented via computer-executable instructions stored on non-transitory computer-readable media or medium.

In some examples, the system includes multiple components distributed among a plurality of computer devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present examples can enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional embodiments that also incorporate the recited features.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An enhanced connectivity computer platform comprising:
a central handler comprising at least one processor in communication with at least one memory device, the central handler configured to maintain a cloud-based infrastructure for a connector application downloadable and executable on a plurality of user computing devices in communication with the central handler;
a first instance of the connector application executed on a first user computing device, the first instance including executable instructions causing a first processor of the first user computing device to display an interactive graphical user interface (GUI) on the first user computing device; and
a background operator of the connector application executed via the first processor, the background operator including executable instructions causing the first processor to:
log user interaction with one or more software applications executed on the first user computing device; and
write an activity profile to at least one of (i) a first memory of the first user computing device or (ii) the at least one memory device of the central handler, the activity profile including a plurality of logged user interactions,
wherein, in response to receiving from a requestor device a first request for first information associated with a user of the first user computing device, the central handler is configured to:
access the activity profile to retrieve one or more data elements responsive to the first request; and
transmit the one or more data elements to the requestor device in a response message.

2. The enhanced connectivity computer platform of claim 1, wherein the requestor device is a newly executed software application being executed on the first user computing device for a first time and is a first type of application, and wherein the first request for first information requests the one or more data elements related to logged user interactions with previously executed applications of a same or similar type to the newly executed software application.

3. The enhanced connectivity computer platform of claim 1, wherein the requestor device is a second user computing device communicatively coupled to the first user computing device.

4. The enhanced connectivity computer platform of claim 3, wherein the first request is initiated with a second instance of the connector application executed on the second user computing device.

5. The enhanced connectivity computer platform of claim 1, wherein at least one of the background operator or the central handler is configured to process the logged user interactions to generate a plurality of learned data elements identifying preferences of the first user, and wherein the first instance of the connector application further causes the first processor to display the GUI including the preferences of the first user and a request for validation of the preferences.

6. The enhanced connectivity computer platform of claim 5, wherein the first instance of the connector application further causes the first processor to receive user input from the GUI including user validation of at least one of the preferences, and wherein the first instance of the software application or the background operator further causes the first processor to write the plurality of learned data elements to the activity profile when the preferences are validated by the first user.

7. The enhanced connectivity computer platform of claim 1, wherein the first instance of the connector application further causes the first processor to:
display the GUI including an interface prompting the first user to provide user input including user preferences;
generate a plurality of manual data elements representing the user preferences; and
write the plurality of manual data elements to the activity profile.

8. The enhanced connectivity computer platform of claim 1, wherein the first instance of the connector application further causes the first processor to display the GUI including an interface prompting the first user to provide user input including access parameters.

9. The enhanced connectivity computer platform of claim 8, wherein the central handler is further configured to determine, based upon the access parameters, the requestor device has permission to access the activity profile and the one or more data elements.

10. The enhanced connectivity computer platform of claim 8, wherein the access parameters define which entities have permission to access the activity profile, and which data elements of the activity profile can be accessed by each of the entities.

11. A computer-implemented method for enhanced resource sharing, the method implemented using a central handler including at least one processor in communication with at least one memory device, the central handler configured to maintain a cloud-based infrastructure for a connector application downloadable and executable on a plurality of user computing devices in communication with the central handler, and a first instance of the connector application executed on a first user computing device including a first processor, the method comprising:
executing, on the first processor, the first instance of the connector application;
causing, by the first instance of the connector application, the first processor to display an interactive graphical user interface (GUI) on the first user computing device;
executing, on the first processor, a background operator of the connector application;
logging, by the background operator, user interaction with one or more software applications executed on the first user computing device;
writing, by the background operator, an activity profile to at least one of (i) a first memory of the first user computing device or (ii) the at least one memory device of the central handler, the activity profile including a plurality of logged user interactions;
in response to receiving from a requestor device a first request for first information associated with a user of the first user computing device, accessing, by the central handler, the activity profile to retrieve one or more data elements responsive to the first request; and
transmitting, by the central handler, the one or more data elements to the requestor device in a response message.

12. The computer-implemented method of claim 11, further comprising:
processing the logged user interactions to generate a plurality of learned data elements identifying preferences of the first user.

13. The computer-implemented method of claim 12, further comprising:
causing the first processor to display the GUI including the preferences of the first user and a request for validation of the preferences.

14. The computer-implemented method of claim 13, further comprising:
receiving user input from the GUI including user validation of at least one of the preferences; and
writing the plurality of learned data elements to the activity profile.

15. The computer-implemented method of claim 11, further comprising:
causing the first processor to display the GUI including an interface prompting the first user to provide user input including user preferences;
generating a plurality of manual data elements representing the user preferences; and
writing the plurality of manual data elements to the activity profile.

16. The computer-implemented method of claim 11, further comprising:
causing the first processor to display the GUI including an interface prompting the first user to provide user input including access parameters, wherein the access parameters define which entities have permission to access the activity profile, and which data elements of the activity profile can be accessed by each of the entities; and
determining, based upon the access parameters, the requestor device has permission to access the activity profile and the one or more data elements.

17. The computer-implemented method of claim 11, further comprising:
maintaining a repository of registered users that are registered with the central handler, wherein the first request includes a registration tag indicating the requestor device is or is associated with one of the registered users.

18. At least one non-transitory computer-readable storage medium having stored thereon computer-executable instructions that, when executed by at least one processor, cause the at least one processor to:
maintain a cloud-based infrastructure for a connector application downloadable and executable on a plurality of user computing devices;
execute, on a first user computing device, a first instance of the connector application;
cause display of an interactive graphical user interface (GUI) on the first user computing device;
execute, on the first user computing device, a background operator;
log user interaction with one or more software applications executed on the first user computing device;
write an activity profile to at least one memory, the activity profile including a plurality of logged user interactions;
in response to receiving from a requestor device a first request for first information associated with a user of the first user computing device, access the activity profile to retrieve one or more data elements responsive to the first request; and
transmit the one or more data elements to the requestor device in a response message.

19. The at least one non-transitory computer-readable storage medium of claim 18, wherein the computer-executable instructions further cause the at least one processor to:
cause display of a prompt for the first user to provide biometric authentication data or a password before permitting access the activity profile or transmit the response message.

20. The at least one non-transitory computer-readable storage medium of claim 18, wherein the computer-executable instructions further cause the at least one processor to:
cause display of the GUI including an interface prompting the first user to provide at least one of: (i) user input including user preferences, (ii) access parameters, or (iii) monitoring parameters.
